(19) United States
(12) Patent Application Publication
(10) Pub. No.: US 2021/0000109 A1
(43) Pub. Date: Jan. 7, 2021

(54) AGRICULTURAL PESTICIDE COMPOSITIONS

(71) Applicant: RHODIA OPERATIONS, Paris (FR)

(72) Inventors: Laurianne, Françoise, Marie MOITY, Lyon (FR); Monique, Martine, Françoise ADAMY, Asnières-sur-Seine (FR)

(21) Appl. No.: 16/761,415

(22) PCT Filed: Nov. 8, 2018
(86) PCT No.: PCT/EP2018/080701

§ 371 Date: May 4, 2020

Related U.S. Application Data
(60) Provisional application No. 62/583,812, filed on Nov. 9, 2017.

(51) Int. Cl. A01N 37/40; A01N 25/30; A01N 25/24

(52) U.S. Cl. CPC A01N 37/40; A01N 25/24; A01N 25/30

(57) ABSTRACT

The present invention relates to an aqueous composition comprising at least an auxin herbicide and a drift control agent. It relates more particularly to a concentrated blend of at least one water-soluble salt of an auxin herbicide and of a drift control agent.

This application claims priority to U.S. provisional application No. 62/583812 filed on Nov. 9, 2017, the whole content of this application being incorporated herein by reference for all purposes.

The present invention relates to an aqueous composition comprising at least an auxin herbicide and a drift control agent.

It relates more particularly to a concentrated blend of at least one water-soluble salt of an auxin herbicide and of a drift control agent.

Auxin herbicides are a well-known class of herbicides used to kill weeds by inducing hormonal effects on sprayed plants. They are thus commonly used to control auxin-susceptible plant growth. Typical representatives of auxin herbicides include 2,4-D (2,4-dichlorophenoxyacetic acid) and dicamba (3,6-dichloro-2-methoxybenzoic acid).

Spray drift is a problem frequently faced when using this class of herbicides.

Spray drift is defined by the Environmental Protection Agency as the movement of pesticide dust or droplets through the air at the time of application or soon thereafter, to any site other than the area intended.

Non-target plant damage associated with auxin herbicide spray drift is a major concern for crop growers nowadays. As a matter of fact, unintentional application of auxin herbicides to a sensitive plant generally causes severe injury, loss of yield, and even death of the non-target plants.

This is the reason why there is an increasing demand today for auxin herbicide compositions with improved spray drift control properties.

Various drift control agents are already known in the art. Drift control agents can be defined as chemical agents that enhance drift control of spray applied pesticide composition and/or provides “anti-rebound” properties to the spray applied pesticide composition, that is, reduces rebound of the spray applied pesticide from a target substrate, such as e.g., the foliage of a target plant.

Typical examples of drift control agents include for instance polysaccharide polymers, polyacrylamide polymers and emulsified fatty compounds.

As a rule, the drift control agent may be added to the spray tank (so-called tank-mix adjuvants) or may be incorporated directly into the concentrated herbicide composition (so-called built-in adjuvants).

Tank mixes are combinations of agricultural products (pesticide formulation and tank mix adjuvant compositions) that a farmer would pour into a tank (in which the tank mix is prepared), with water and perhaps other additives, mix (optionally by stirring) and then apply on the field shortly thereafter, as these mixes are typically not stable for extended periods of time. However, tank mixes face a variety of issues such as use of incorrect ingredients, human error in measuring the relative component amounts, and improper mixing steps. This can result in reduced effectiveness of the spray formulation, precipitation or gelation in the tank, clogged spray nozzles or clogged screens, excessive residue or runoff, or plant phyto-toxicity.

The use of known drift control agents for preparing a tank mix composition of an auxin herbicide has already been reported in the past.

Given the drawbacks associated with tank mixes, there remains a need today for stable concentrated compositions of one water-soluble salt of an auxin herbicide that contain a sufficient amount of a drift control agent in a one-pack concept (built-in), that is to say for composition of one water-soluble salt of an auxin herbicide that comprises a relatively high concentration of an auxin herbicide, in particular a high concentration of a water-soluble salt of an auxin herbicide, and of a drift control agent, and that is intended to be heavily diluted at the point of use to provide an auxin herbicide composition for application to target pests exhibiting an improved drift control.

In particular, there remains a need today for stable concentrated compositions of at least one water-soluble salt of an auxin herbicide that contain a relatively high amount of a water-soluble salt (whether it be a water-soluble salt of said auxin herbicide alone or a combination of a water-soluble salt of said auxin herbicide with a water-soluble salt of an additional herbicide and/or with added water-soluble salt) and a sufficient amount of a drift control agent and that does not require the use of a separate tank-mix adjuvant by the end user to realize the full biological potential of the dose of herbicide applied per unit crop area and/or to achieve acceptable drift control.

There remains more particularly a need today for stable concentrated compositions of at least one water-soluble salt of an auxin herbicide that exhibit at the same time acceptable storage stability, dilution miscibility and stability and acceptable spray drift control properties when said concentrated composition is diluted in water in a spray tank for soil or foliar application.

One of the major challenges to resolve the above-mentioned technical problems is to incorporate significant amounts of known drift control agents, such as for instance polysaccharide polymers, polyacrylamide polymers and emulsified fatty compounds, into concentrated compositions of at least one water-soluble salt of an auxin herbicide containing a relatively high amount of a water-soluble salt (whether it be a water-soluble salt of said auxin herbicide alone or a combination of a water-soluble salt of said auxin herbicide with a water-soluble salt of an additional herbicide and/or with added water-soluble salt), while improving at least one of the target attributes of said concentrated composition, in particular storage stability, dilution miscibility and stability and acceptable spray drift control properties when said concentrated composition is diluted in water in a spray tank for soil or foliar application.

Incorporating significant amounts of drift control agents is critical in concentrated compositions since, as mentioned previously, said concentrated compositions are then intended to be heavily diluted at the point of use and the diluted composition shall include a minimum amount of said drift control agent to achieve acceptable drift control.

It is widely known that typical polymeric drift control agents, in particular water-soluble polymers such as polysaccharide polymers (e.g. guars) or polyacrylamide polymers, need to be added into such formulations in a suspended form (for instance in a incompletely hydrated form) to avoid a significant and detrimental increase in viscosity. As a matter of fact, even a low amount of water-soluble polymer, when in a hydrated state, can yield to a formulation that is no longer pourable, for example, as a gel.

When the drift control agent is in the form of an emulsified fatty compound, it is common to use a suspending agent to favor long term stability of the emulsion in order to avoid phase separation which would be also detrimental to the formulation stability and/or to the drift control properties.

The main difficulty lies in the fact that the performances of traditional suspending agents, such as for instance xanthan gum, or silica used in the prior art, are reduced in the presence of a relatively high amount of a water-soluble salt, which may especially impact some target attributes, such as for instance storage stability over time. As a matter of fact, the presence of a relatively high amount of a water-soluble salt (and thus a high electrolytic level) in the concentrated composition can potentially prevent the full hydration of such traditional suspending agents, thereby negatively impacting their performances.

This may result, for instance, in deteriorated suspending properties or in a negative impact on long term stability or in the presence of residual gel particles, or even in the hydration of water-soluble drift control polymers, leading to progressive viscosity increase of the composition or to rapid phase separation.

There remains thus a need for new drift control agents making it possible to prepare stable concentrated compositions of at least one water-soluble salt of an auxin herbicide, especially in the presence of a relatively high amount of a water-soluble salt, without a need for a suspending agent.

It is in particular desirable to provide a stable concentrated composition of at least one water-soluble salt of an auxin herbicide and of at least one drift control agent that exhibit improved properties especially in terms of storage stability, dilution miscibility and stability and/or acceptable spray drift control properties when said concentrated composition is diluted in water in a spray tank for soil or foliar application.

It has now been discovered, unexpectedly, that the use of a specific drift control agent made it possible to achieve this goal.

In particular, it has been discovered that the specific drift control agent of the invention as described below was soluble in the concentrated composition of the invention (namely in concentrated formulations containing a relatively high amount of a water-soluble salt as described previously) and therefore made it possible advantageously to avoid the need for a suspending agent.

The present invention relates to, in one aspect, a pesticide composition comprising, by total weight of the composition:
a pesticide comprising at least one water-soluble salt of an auxin herbicide; and
greater than about 0.5 wt % of a drift control agent comprising (a) at least one fatty deposition control agent that comprises one or more fatty acids, and (b) at least one surfactant.

Advantageously, the drift control agent is present in a soluble form in the pesticide composition of the invention.

The drift control agent of the invention is thus different for instance from fatty drift control agent formulated as an emulsion, which require the presence of an adequate suspending agent to remain suspended in the composition.

Should the disclosure of any patents, patent applications, and publications which are incorporated herein by reference conflict with the description of the present application to the extent that it may render a term unclear, the present description shall take precedence.

### AUXIN HERBICIDE

The term “auxin herbicide” refers to a herbicide that functions as a mimic of an auxin plant growth hormone, thereby affecting plant growth regulation. Examples of auxin herbicides that are suitable for use in the herbicidal compositions of the present invention include, without limitation, benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides.

According to anyone of the invention embodiments, the auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-quinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

According to anyone of the invention embodiments, the auxin herbicide is dicamba, or an agriculturally acceptable salt or ester thereof, for instance dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt or dicamba dimethylamine salt. In one embodiment, the dicamba salt is (i) a secondary, tertiary or quaternary alkylamine or (ii) a primary, secondary, tertiary or quaternary alkanolamine, alkylalkanolamine or alkoxyalkanolamine salt, wherein the alkyl and alkanol groups are saturated and contain from C1-C4 carbon atoms.

According to anyone of the invention embodiments, the pesticide comprises a dicamba salt, wherein the salt is N,N-bis(3-aminopropyl)methylamine, diethanolamine, monoethanolamine, dimethylamine, isopropylamine, dimethylethanolamine, diglycolamine, potassium, choline, or sodium.

According to anyone of the invention embodiments, the pesticide comprises dicamba diglycolamine (DGA) salt or dicamba N,N-bis(3-aminopropyl)methylamine (BAPMA) salt.

Other dicamba salts that can be used according to the present invention, especially dicamba polyamine salts, are recited for instance in WO2013/189773 which is herein incorporated by reference in its entirety.

According to another one of the invention embodiments, the herbicidal composition comprises at least 2,4-D, or an agriculturally acceptable salt or ester thereof.

For instance, a herbicidal composition of the invention may comprise a 2,4-D salt selected in the group consisting of: the choline, dimethylamine, and isopropylamine salts, and combinations thereof.

For instance, a herbicidal composition of the invention may comprise a 2,4-D ester selected in the group consisting of: the methyl, ethyl, propyl, butyl (2,4-DB), and isooctyl esters, and combinations thereof.

According to anyone of the invention embodiments, the concentrated composition of the invention contains at least one water-soluble salt of an auxin herbicide as described previously, in particular at least one agriculturally acceptable water-soluble salt of dicamba, for instance dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt or dicamba dimethylamine salt, and combinations thereof.

According to anyone of the invention embodiments, the concentrated composition of the invention contains at least one water-soluble salt of an auxin herbicide as described previously, in particular at least one agriculturally acceptable water-soluble salt of 2,4-D, for instance 2,4-D choline salt, 2,4-D dimethylamine salt, or 2,4-D isopropylamine salt, and combinations thereof.

A concentrated composition of the invention usually contains at least 300 g/l, more preferably at least 400 g/l, and in particular at least 450 g/l acid equivalents (a.e.) of auxin herbicide, in particular dicamba.

According to anyone of the invention embodiments, the concentrated composition of the invention may comprise at least 300 g/L acid equivalents (a.e.) of at least one water-soluble salt of an auxin herbicide, in particular dicamba.

A concentrated composition of the invention contains usually up to 800 g/l, preferably up to 700 g/l, more preferably up to 650 g/l, and in particular up to 600 g/l acid equivalents (a.e.) of auxin herbicide, in particular dicamba.

### AQUEOUS LIQUID MEDIUM

A composition of the invention comprises an aqueous liquid medium.

As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous medium comprises, based on 100 pbw of the aqueous medium, greater than 40 pbw water, more typically, greater than 50 pbw water. The aqueous medium may, optionally, further comprise water soluble or water miscible components dissolved in the aqueous medium. The terminology “water miscible” as used herein means miscible in all proportions with water. Suitable water miscible organic liquids include, for example, (C₁-C₃)alcohols, such as methanol, ethanol, and propanol, and (C₁-C₃)polyols, such as glycerol, ethylene glycol, and propylene glycol.

According to anyone of the invention embodiments, a composition of the invention comprises greater than about 5 wt % of an aqueous liquid medium, for instance greater than about 10 wt %, for instance from about 10 wt % to about 80 wt %, for instance from about 15 wt % to about 75 wt % of an aqueous liquid medium relative to the total weight of the composition.

### DRIFT CONTROL AGENT

As used herein, the term “drift” refers to off-target movement of droplets of a pesticide composition that is applied to a target pest or environment for the pest. Spray applied compositions typically exhibit decreasing tendency to drift with decreasing relative amount, typically expressed as a volume percentage of total spray applied droplet volume, of small size spray droplets, that is, spray droplets having a droplet size below a given value, typically, a droplet size of less than 150 micrometers (“μm”). Spray drift of pesticides can have undesirable consequences, such as for example, unintended contact of phytotoxic pesticides with non-pest plants, such as crops or ornamental plants, with damage to such non-pest plants.

In one embodiment, spray drift can me measured as follows : the aqueous pesticide compositions as described herein are sprayed through a nozzle under certain conditions, for example, a single, stationary XR11002 flat fan nozzle (Teejet) with an output of 0.64 liter in⁻¹ at a pressure of 30 psi (˜2 bar) in a flow-controlled hood (speed ˜1.6 MPH), and a droplet size distribution was measured perpendicular to the plane of spray pattern and below the nozzle tip, e.g., 35 cm. An analyzer such as a HELOS VARIO particle size analyzer (Sympatec) can be used to measure the spray droplets using a R7 lens. The volume mean diameter (“VMD”) of the spray droplets, expressed in micrometers (“μm”), and relative amount, expressed as percent by volume of the total spray volume (“vol %”), of droplets below 150 μm can be ascertained. It is desireable for spray compositions to exhibit a smaller amount of small size spray droplets that are very susceptible to spray drift, i.e., droplets below 150 μm in size, compared to respective analogous compositions or compositions without a drift control agent.

The drift control agent of the invention comprises a deposition aid of at least one fatty deposition control agent and at least one surfactant.

In one particular embodiment, the drift control agent comprises: (a) at least one fatty deposition control agent that comprises one or more fatty acids, and (b) at least one surfactant.

In one embodiment, the fatty acid used as the fatty deposition control agent is oleic acid, linoleic acid, erucic acid, docosenoic acid, docosahexenoic acid, tall oil fatty acid, a combination thereof, as well as salts thereof and mixtures of such acids and/or salts.

In another embodiment, the fatty acid used as the fatty deposition control agent is oleic acid, linoleic acid, erucic acid, tall oil fatty acid, a combination thereof, salts thereof and/or mixtures of such acids and/or salts.

In yet a further embodiment, the fatty acid used as the fatty deposition control agent is tall oil fatty acid and/or salts thereof.

The surfactant can be any suitable surfactant known in the art.

For instance, suitable surfactants include but are not limited to polyalkoxylated triglycerides, fatty acid glycol ester surfactants, or a combination thereof.

In another embodiment, the drift control agent comprises (a) at least one fatty deposition control agent comprising one or more fatty acids as described previously, and (b) at least one surfactant comprising a polyalkoxylated triglyceride.

In one particular embodiment, a concentrated composition of the invention may comprise a drift control agent as described previously in an amount greater than 1% by weight of composition, for instance in an amount ranging from 1% by weight to 50% by weight, in particular from 5% by weight to 30% by weight, for instance from 10% by weight to 25% by weight, relative to the total weight of the composition.

In one embodiment, the composition of the present invention exhibits a viscosity of less than 10 Pa·s, more typically from about 0.1 to less than 10 Pa·s, at a shear rate of greater than or equal to 10 s⁻¹. In one embodiment, the composition of the present invention exhibits a viscosity of less than 7 Pa·s, more typically from about 0.1 to less than 7 Pa·s, at a shear rate of greater than or equal to 10 s⁻¹. In one embodiment, the composition of the present invention exhibits a viscosity of less than 5 Pa·s, more typically from about 0.1 to less than 5 Pa·s, at a shear rate of greater than or equal to 10 s⁻¹.

In one embodiment, such a viscosity profile equates to the composition being flowable, i.e., able to be pumped. This characteristic is an advantage as end use applications from a storage container typically prefer to pump components into the final application tank for crop application. For example, typically farmers will add components for a final tank mix into separate tanks, such as a tank for water, a tank for an adjuvant composition, a tank for a water conditioner, and have those components pumped into a final end use application tank.

In one embodiment, the composition of the present invention is prepared on an as needed basis and is sufficiently stable, that is, a quiescent sample of the composition shows no evidence, by visual inspection, of gravity driven separation, such as, separation into layers and/or precipitation of components, such as, for example, separation of incompletely hydrated water-soluble polymer from the liquid medium, within the anticipated time period.

In one embodiment, the composition of the present invention exhibits good storage stability and a quiescent sample of the composition shows no evidence, by visual inspection, of gravity driven separation within a given time, such as, for example, one week, more typically, one month, even more typically 3 months, under given storage conditions, such as, for example, at room temperature. In another embodiment, the composition of the present invention exhibits good storage stability and a quiescent sample of the composition shows no evidence, by visual inspection, of gravity driven separation within a given time, which in one embodiment is one week, more typically, one month, even more typically 3 months, under high temperature storage conditions, e.g., greater than 50° C. In one embodiment, the composition of the present invention is shelf stable (i.e., exhibits at least part of the good storage stability as detailed above) at a temperature greater than 50° C. for at least 24 hours, or 48 hours, or in yet another embodiment, 72 hours.

In one embodiment, the composition of the present invention exhibits good storage stability and a quiescent sample of the composition shows no evidence, by visual inspection, of gravity driven separation within a given time, such as, for example, 24 hours, more typically, four days, even more typically, one week, under accelerated aging conditions at an elevated storage temperature of up to, for example, 54° C., more typically, 45° C.

In one embodiment, a concentrated composition of the invention exhibits a Brookfield viscosity at 25° C. and at 20 rpm of less than or equal to about 5,000 centiPoise (“cP”), more typically of less than or equal to 2,500 cP, for example from about 10 to about 1,500, especially from about 10 to about 1,000 cP.

A concentrated composition of the invention exhibits good storage stability. The criteria for assessing storage stability are that the formulation remains substantially homogeneous in visual appearance during storage and does not separate into layers of mutually insoluble liquid phases and does not form any solid precipitate upon quiescent standing.

In one embodiment, the concentrated composition of the invention remains stable during storage at temperatures from −5° C. to 54° C. for greater than or equal to 7 days, more typically for greater than or equal to 14 days (adaptation of CIPAC test MT46.3).

The concentrated composition of the invention remains stable during storage at room temperature for more than or equal to 7 days, more typically for greater than or equal to 14 days and even more typically for greater than or equal to 30 days.

A concentrated composition of the invention also exhibits good dilution stability and/or provides a suitable dispersion.

The term “suitable dispersion” is intended to denote a dispersion after dilution in water (CIPAC standard waters A or D) which exhibits substantially no or little phase separation (sedimentation, creaming, etc)) over time, in particular when it is stored for 30 minutes in a water bath thermostatted at 30° C., preferably for 2 hours in a water bath thermostatted at 30° C. and ideally for 24 hours in a water bath thermostatted at 30° C. (adaptation of CIPAC test MT41 and MT184).

The concentrated composition of the invention may comprise additional pesticides in addition to the auxin herbicide.

Suitable additional pesticides are pesticides as defined below. Preferred additional pesticides are herbicides, such as
amino acid derivatives: bilanafos, glyphosate (e.g. glyphosate free acid, glyphosate ammonium salt, glyphosate isopropylammonium salt, glyphosate trimethylsulfonium salt, glyphosate potassium salt, glyphosate dimethylamine salt), glufosinate (e.g. glufosinate ammonium salt), sulfosate;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlor-prop, MCPA, MCPA-thioethyl, MCPB, Mecoprop.

More preferred additional pesticides are glyphosate and glufosinate.

According to anyone of the invention embodiments, a concentrated composition of the invention may comprise, in addition to said water-soluble salt of an auxin herbicide, at least one water-soluble salt of at least one additional herbicide.

For instance, a concentrated composition of the invention may further comprise at least one water-soluble salt of glyphosate and/or at least one water-soluble salt of glufosinate. According to anyone of the invention embodiments, the total amount of water-soluble salts (whether it be a water-soluble salt of said auxin herbicide alone or a combination of a water-soluble salt of said auxin herbicide with a water-soluble salt of an additional herbicide and/or with added water-soluble salt) may be of at least 300 g/L.

According to anyone of the invention embodiments, a concentrated composition of the invention may also comprise, in addition to said water-soluble salt of an auxin herbicide, at least one additional herbicide which is insoluble in said concentrated composition, for instance present in a dispersed form.

According to another one of the invention embodiments, a concentrated composition of the invention may also comprise, in addition to said water-soluble salt of an auxin herbicide, at least one additional herbicide present in a soluble form in a liquid medium different from the aqueous continuous phase and which is non-miscible in said aqueous phase, with said liquid medium being present in an emulsified form in said concentrated composition. Suspo-emulsions are typical examples of such compositions.

The concentrated composition of the invention may comprise auxiliaries, such as volatilization reduction additives, solvents, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants.

Suitable solvents and liquid carriers are organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate. The alkoxylate of the formula (I) is not a nonionic surfactant within the meaning of this invention. Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are for instance polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones, alkylchloroisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Advantageously, a concentrated composition of the invention does not comprise any suspending agent and/or thickeners. In particular, a concentrated composition of the invention may comprise less than 2% by weight of suspending agents and/or of thickeners relative to its total weight, for instance less than 1% by weight, for instance less than 0.5% by weight, for instance less than 0.1% by weight.

Typical suspending agents and/or thickeners include for instance polysaccharides (e.g. xanthan gum, carboxymethylcellulose), anorganic clays (organically modified or unmodified), polycarboxylates, and silicates.

In one embodiment, the composition of the invention is free or substantially free of ammonium-containing water conditioning agent, in particular ammonium sulfate. In one embodiment, the composition is concentrated blend of a at least one an auxin herbicide or salt thereof, a drift control agent as defined previously, which composition is stable, has a low viscosity, is easily transportable, is pourable and pumpable under field conditions, and is dilutable with water under field conditions to form a dilute pesticide composition for spray application to target pests.

In one embodiment, the concentrated pesticide composition of the present invention is diluted with water, typically in a ratio of from 1:10 to 1:1,000 parts by weight pesticide concentrate composition: parts by weight water, for instance in a ratio of from 1:10 to 1:100 parts by weight pesticide concentrate composition: parts by weight water to form a dilute pesticide composition for spray application to target plants.

Optionally, other components, such as additional pesticide, polymer, surfactants, fertilizer, and/or other adjuvants, may be added to the dilute pesticide composition.

In one embodiment, the pesticide composition of the present invention is applied, in dilute form, to foliage of a target plant at a rate of from about 0.25 pint, more typically about 0.5 pint, to about 5 pints, even more typically from about 1 pint to about 4 pints, as expressed in terms of the above described pesticide concentrate embodiment of the pesticide composition of the present invention (that is, comprising, based on 100 pbw of such composition, up to about 70 pbw, more typically from about 10 to about 60 pbw, more typically from about 25 to about 55 pbw, pesticide) per acre.

In one embodiment, the pesticide composition is spray applied in dilute form via conventional spray apparatus to foliage of one or more target plants present on an area of ground at a rate of from about 1 gallon to about 20 gallons, more typically about 3 gallons to 20 gallons, of the above described diluted pesticide composition per acre of ground.

The pesticide compositions of the invention may advantageously also be useful to reduce volatility of said auxin herbicide and off-site movement of said auxin herbicide.

Volatilization occurs when pesticide surface residues change from a solid or liquid to a gas or vapor after an application of a pesticide has occurred. Once airborne, volatile pesticides can move long distances off site (and in particular longer distances compared to spray drift).

Another object of the present invention is to provide auxin herbicide compositions having reduced volatility relative to currently available compositions, and preferably reduced-volatility compositions that exhibit no significant reduction in herbicidal effectiveness relative to currently available compositions.

Advantageously, it is believed that the compositions of the present invention provide enhanced protection from off-target crop injury while maintaining comparable herbicidal efficacy on auxin-susceptible plants located in the target area.

Impact on the auxin herbicide volatility can be measured by conventional means known to those skilled in the art.

For instance, volatilization of an auxin herbicide can be assessed as follows : an auxin herbicide composition is heated, causing the auxin herbicide to volatilize from said composition into the gas phase. Weight of residual auxin herbicide composition is recorded against time (through thermogravimetric analyses), allowing indirect measurement of volatilization of the auxin herbicide.

Some details or advantages of the invention will appear in the non-limitative examples below.

### EXAMPLES

The composition of Example 1 was an aqueous herbicide composition that contained a pesticide (N,N-bis(3-aminopropyl)methylamine salt of Dicamba) and a fatty drift control agent A The composition of Comparative Example 1 was analogous to that of Example 1, but with another fatty drift control agent.

The composition of the fatty drift control agent A was prepared as follows. Fatty acid deposition control agent was made by blending 90% wt. fatty deposition control agent (Tall oil fatty acid, ForChem) and 10% wt. surfactant (an ethoxylated castor oil surfactant Alkamuls BR, Solvay).

The composition of the fatty drift control agent B was prepared as follows. Fatty acid deposition control agent was made by blending 85% wt. fatty deposition control agent (Soybean oil) and 15% wt. surfactant (an ethoxylated glycol ester of fatty acid, Alkamuls VO/2003, Solvay).

The compositions were prepared as follows. During all the preparation, the medium was stirred using an inox deflocculating blade (diameter 35 mm) at a speed of 800 rpm. 84.99% wt. Engenia™ (N,N-bis(3-aminopropyl)methylamine salt of Dicamba, 600 g/L a.e. BASF) were introduced in a plastic beaker. Then 15.01% wt. fatty drift control agent A were slowly introduced. The formulation was then left for 1.5 hours under stirring (800 rpm).

The stability of each of the compositions was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time. Comparative example C1 was not stable as top layer appeared after 2 weeks at 54° C. Example 1 was stable and showed no evidence of viscosity increase and precipitation or separation into layers for 2 weeks at 54° C. and 2 months at room temperature.

The viscosity of each of the compositions was measured at room temperature using a Brookfield LV viscometer equipped with a SP2 spindle at 20 revolutions per minute (“rpm”).

The materials and their relative amounts used to make the compositions of Examples 1 and C1 are set forth in Table I below and the stability results for Example 1 and Comparative Example C1 are set forth in Table I-A below.

TABLE I
Concentrated aqueous BAPMA Dicamba
herbicide compositions

| | EX 1 | CEX1 |
|---|---|---|
| Materials | % wt. | % wt. |
| Aqueous solution of N,N-bis | 84.99 | 85.05 |
| (3-aminopropyl)methylamine salt of | | |
| Dicamba (Engenia ™) | | |
| fatty drift control agent A | 15.01 | — |
| (Solvay) | | |
| fatty drift control agent B | — | 14.95 |
| (Solvay) | | |

TABLE I-A

| | | EX 1 | CEX1 |
|---|---|---|---|
| Before | Viscosity | limpid, Very easy | Veiled, Very easy |
| storage | (Brookfield | to flow (<700 cP) | to flow (<700 cP) |
| | LV, SP62 @RT) | | |
| After | Aspect | 14 days 54° C.: stable | 14 days 54° C.: |
| storage | | 2 months RT: stable | 10% top syneresis |
| | | | 14 days RT: |
| | | | 5% top syneresis |

RT = Room Temperature

### Drift Measurements

The aqueous spray compositions of Example 1 and Engenia™ were made by diluting compositions Example 1 and Engenia™ (BASF) in 342 ppm hardness CIPAC water to provide dilute aqueous mixtures containing the relative amount of the respective compositions Example 1 and Engenia™ as percent by weight of the dilute composition in Table II below.

The dilute aqueous compositions thus obtained were sprayed through a single flat fan nozzle Al11003-VS at a pressure of 40 psi in a flow-controlled hood (speed 1.6 mph) and the droplet size distribution was measured perpendicular to the plane pf spray pattern and 12 inches below the nozzle tip. A Sympatec Laser HELOS-VARIO/KR multi range (Sympatec GmbH, Germany) was used to measure the spray droplets using a R7 lens.

Two parameters V<150 (% of volume of spray droplets of less than 150 microns (i.e., representative of driftable fines)) and VMD (Volume Median Diameter (defined as the droplet size below which 50% volume of spray is contained)) are reported in the Table II. The spray compositions of Example 1 exhibited a smaller amount of small size spray droplets that are very susceptible to spray drift, i.e. below 150 μm in size, compared to respective analogous compositions of Engenia™.

TABLE II

| | g/L a. e. Dicamba | | Vol, | |
|---|---|---|---|---|
| | in dilute | % fatty drift | <150 | VMD |
| | composition | control agent | μm (%) | (μm) |
| 1.7% wt. | 10.20 | 0 | 9.79 | 436.12 |
| Engenia ™ | | | | |
| 2% wt. | 10.20 | 0.30 | 7.81 | 439.12 |
| Example 1 | | | | |

1-14. (canceled)

15. A pesticide composition comprising, by total weight of the composition:
a pesticide comprising at least one water-soluble salt of an auxin herbicide;
greater than about 0.5 wt % of a drift control agent comprising (a) at least one fatty deposition control agent that comprises one or more fatty acids, and (b) at least one surfactant.

16. The composition of claim 15, wherein the fatty acid used as the fatty deposition control agent is oleic acid, linoleic acid, erucic acid, docosenoic acid, docosahexenoic acid, tall oil fatty acid, a combination thereof, as well as salts thereof and mixtures of such acids and/or salts.

17. The composition of claim 15, wherein the fatty acid used as the fatty deposition control agent is oleic acid, linoleic acid, erucic acid, tall oil fatty acid, a combination thereof, salts thereof and/or mixtures of such acids and/or salts.

18. The composition of claim 15, wherein the fatty acid used as the fatty deposition control agent is tall oil fatty acid and/or salts thereof.

19. The composition of claim 15, wherein the composition comprises said drift control agent in an amount greater than 1% by weight of the composition, relative to the total weight of the composition.

20. The composition of claim 15, wherein the composition comprises greater than about 5 wt % of an aqueous liquid medium, relative to the total weight of the composition.

21. The composition of claim 15 further comprising the presence of at least 300 g/L of water soluble salts.

22. The composition of claim 15, wherein the composition comprises at least 300 g/L a.e. of the at least one water-soluble salt of the auxin herbicide.

23. The composition of claim 15, wherein the pesticide comprises a dicamba salt, wherein the salt is N,N-bis(3-aminopropyl)methylamine, diethanolamine, monoethanolamine, dimethylamine, isopropylamine, dimethylethanolamine, diglycolamine, potassium, choline, or sodium.

24. The composition of claim 15, wherein the pesticide comprises dicamba diglycolamine salt or dicamba N,N-bis(3-aminopropyl)methylamine salt.

25. The composition of claim 15 further comprising one or more surfactants.

26. The composition of claim 15, wherein the composition exhibits a viscosity of less than 10 Pa·s at a shear rate of greater than or equal to 10 s⁻¹.

27. The composition of claim 15, wherein the composition exhibits:
(a) a viscosity of greater than or equal to 5 Pa·s at a shear rate of less than 0.01 s⁻¹, and
(b) a viscosity of less than 5 Pa·s at a shear rate of greater than 10 s⁻¹.

28. The composition of claim 15, wherein the composition is free or substantially free of ammonium-containing water conditioning agent.

29. The composition of claim 15 comprising from 5% by weight to 30% by weight of the drift control agent, relative to the total weight of the composition.

30. The composition of claim 15 comprising from 10% by weight to 25% by weight of the drift control agent, relative to the total weight of the composition.

31. The composition of claim 15 comprising from about 10 wt % to about 80 wt % of an aqueous liquid medium, relative to the total weight of the composition.

32. The composition of claim 15 comprising from about 15 wt % to about 75 wt % of an aqueous liquid medium, relative to the total weight of the composition.

33. The composition of claim 15, wherein the composition is free or substantially free of ammonium sulfate.
